(19) United States
(12) Patent Application Publication
(10) Pub. No.: US 2012/0032847 A1
(43) Pub. Date: Feb. 9, 2012

(54) INTEGRATED RECONFIGURABLE SOLAR PANEL ANTENNA

(75) Inventor: Reyhan Baktur, Logan, UT (US)

(73) Assignee: Utah State University, North Logan, UT (US)

(21) Appl. No.: 13/198,970

(22) Filed: Aug. 5, 2011

Related U.S. Application Data
(60) Provisional application No. 61/371,097, filed on Aug. 5, 2010.
(60) Provisional application No. 61/375,084, filed on Aug. 19, 2010.

(51) Int. Cl. H04B 7/10; H01Q 3/00; H01Q 1/28; H01Q 13/10; H01Q 1/22

(52) U.S. Cl. 342/365; 343/770; 343/720; 343/712; 342/372

(57) ABSTRACT

A system for dynamically reconfiguring the radiation pattern of a collection of slot antennas. A collection of slot antennas of various lengths and widths are fabricated. The control system independently drives the feed to one or more slot antennas to produce the desired radiation pattern. The control system activates and deactivates the feed to different slot antennas, thus dynamically reconfiguring the generated radiation pattern.

### RELATED APPLICATIONS

This patent claims the benefit of U.S. Provisional Application 61/371,097, filed Aug. 5, 2010 and entitled INTEGRATED RECONFIGURABLE SOLAR PANEL ANTENNA, and claims the benefit of U.S. Provisional Application 61/375,084, filed Aug. 19, 2010 and entitled INTEGRATED RECONFIGURABLE SOLAR PANEL ANTENNA, both of which are hereby incorporated herein by reference.

### FIELD OF THE INVENTION

This invention relates to an integrated apparatus for transmitting and receiving electromagnetic waves and collecting solar energy, and in particular to a reconfigurable slot antenna system, integrated with solar panels, in which the radiation pattern can be dynamically adjusted.

### BACKGROUND OF THE INVENTION

A slot antenna consists of a conducting surface containing a narrow slot. When driven by a driving frequency and an effective matching mechanism, the slot radiates electromagnetic waves. The slot size and shape, as well as the driving frequency and phase, are design variables that determine the radiation distribution pattern and thus the performance of the system.

A typical solar panel consists of layers of material to support and attach solar cells on the outmost surface. Solar cells are then connected to collect maximum power harvested. There are gaps between solar cells to leave enough spaces for solar cell connections.

What is needed is a system in which slot antennas are integrated into solar panels in such a way that the radiation pattern can be dynamically adjusted.

One of the biggest challenges for a satellite is how to allocate the limited surface real estate. In general, the surface area is occupied by surface mounted solar cells, test instruments for specific mission, and antennas as part of the communication system. Most satellites use the wire type dipole antenna, and usually there is a deployment mechanism associated with this type of antennas. Before launching the satellite, the dipole antennas are mounted at designated locations and are folded on the surface of the satellite. After the satellites are launched and reach their orbits, the dipole antennas then pop open and stick out from the satellite. There are main three disadvantages for dipole antennas. First, the deployment mechanism requires extra mechanical design and is not cost-friendly. Second, in the case that the antenna does not pop open, the entire communication system may fail resulting is losing the whole spacecraft. Third, the antenna properties are limited by the mounting location on the satellite and one cannot always achieve the best antenna design.

In the instant invention the antennas are integrated with the solar panel, and one can flexibly design the desired radiation pattern and polarization. The proposed antenna is conformal with the satellite surface and does not occupy any additional surface area. The antenna design and solar cells are independent, and one can flexibly choose after-market solar cells to assemble a solar panel. This feature is particularly valuable for small satellite applications because it helps reduce the satellite payload with no requirement of custom made solar cells. The instant antennas are based on slot antennas.

In satellite application, it is important to be able to use one single set of instruments and reuse them in different missions by sampling reconfiguration. For antenna design, it is beneficial to integrate antennas with solar panel. It reduces an enormous amount of payload if one integrated solar panel antenna can provide different gain, polarization, and frequency requirements. Therefore, by switching between configurations of antenna elements, such a panel can be used for different flight missions without redesigning the antenna systems.

### SUMMARY OF THE INVENTION

The slot size, number of active slots, and shapes of slot antennas, and phase difference between slot antennas are designed to produce the desired radiation distribution pattern for a specific antenna application. The disclosed invention incorporates the design and fabrication of a collection of multiple slots of various dimensions into a conducting surface to act as a reconfigurable slot antenna system. The excitations to the different slots are controlled independently, thus allowing one or more different slots to be active. By controlling and changing the feed to the different slots, the radiation pattern of the antenna system can be dynamically adjusted for various purposes. The new system is instrumental in small satellite applications where antennas and solar panels are integrated onto one surface to reduce the entire payload, and one single antenna/solar panel can be reconfigured and used for multiple different missions.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 illustrates the ability of a reconfigurable slot antenna system to generate a radiation pattern of desired geometry.

FIG. 2 shows a representation of one embodiment in which several slot antennas of various dimensions are fabricated on a panel containing other components and devices.

FIG. 3 shows one possible feed configuration for a slot antenna.

FIGS. 4a and 4b show representations of different radiation patterns that can be obtained by the dynamic adjustment of the feed to various slots in a reconfigurable slot antenna system.

FIG. 5 shows integrating solar cells and antenna with solar cells 501, upper substrate 502 and lower substrate 503.

FIG. 6 shows a circularly polarized cavity-backed slot antenna.

FIG. 7 shows a feeding network to obtain circular polarization.

FIG. 8 is a two-element LP array.

FIG. 9 is a four-element CP antenna array.

FIG. 10 shows a feeding network to obtain CP.

FIG. 11 is an illustration of the dual band antenna.

FIG. 12 shows an equivalent circuit of the dual band slot antenna.

FIG. 13 shows a; (a) linear array, and (b) nonlinear array.

FIG. 14 shows geometry of a 16-element planar array.

FIG. 15 shows elements on a panel (a) without coupling effect, and (b) with coupling effect.

FIG. 16 shows a solar panel for isotropic-like pattern antenna.

FIG. 17 shows a solar panel for dipole-like pattern antenna.

FIG. 18 shows a solar panel for circular polarization antenna.

### DETAILED DESCRIPTION OF SELECTED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

This disclosure presents an innovative solution for satellite antennas by integrating slot antennas and solar cells on the same panel to save satellite surface real estate and to replace deployed wire antennas for certain operational frequencies. The three main advantages of the proposed antenna are: 1) the antenna does not require an expensive deployment mechanism that is required by dipole antennas; 2) the antenna does not occupy as much valuable surface real estate as patch antennas. The antenna design is based on using the spacing between the solar cells to etch slots in these spaces to create radiating elements; 3) by simply turning on and off certain antennas, a diverse range of antenna gain, polarization, and frequency can be achieved.

In order to illustrate the invention, three exemplary embodiments are discussed. The first embodiment is a circularly polarized antenna. The second embodiment is a linearly polarized two-element antenna array. The third embodiment is a dual band linearly polarized antenna array.

In one embodiment, a collection of slot antennas are integrated with solar cells, sensors, and other components on the surface of satellite structures. Integrated solar panel antennas are designed for maximum functionality within the constraints of limited surface area and low power. Designing and integrating slot antennas into the surface structure provides a more optimal radiation pattern compared to traditional dipole antennas. In addition, slot antennas allow for increased flexibility in shaping the radiation pattern and polarization. By creating extra slot antennas and by reconfiguring these antennas, the radiation pattern can be dynamically changed.

Most solar panels on small satellites are made of printed circuit board material with solar cells laid on top, and narrow gaps exist between solar cells to enable electric connections. The integrated solar panel slot antennas are designed by realizing effective radiating slot elements in those gaps. The slot elements can be produced by etching the printed circuit boards. These slot antennas are highly integrative and lie on the same plane with the solar cells without blocking solar energy.

Slot antennas are preferred over dipole antennas for small satellite applications because mounting dipole antennas may result in surface area and location conflicts with the required solar cells. Repositioning the dipole antennas may sacrifice gain and be an extra burden on ground station receivers. Also, dipole antennas require an expensive deployed mechanism which results in increased satellite payload.

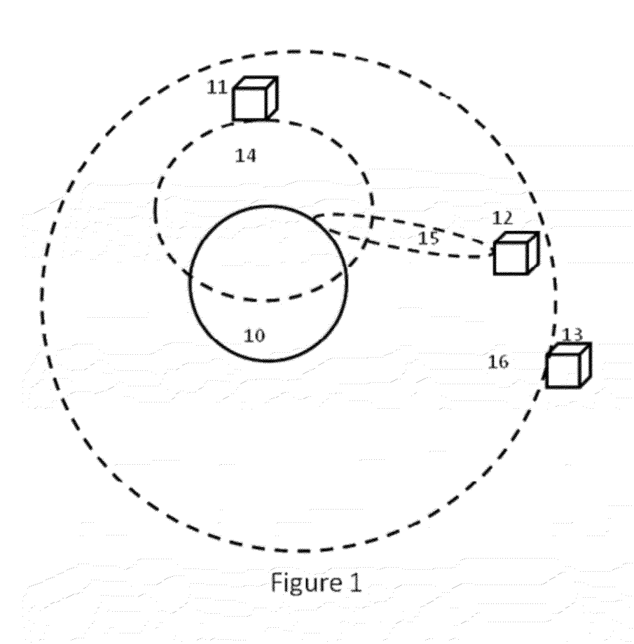

The present disclosure of a reconfigurable slot antenna system can be described with reference to the Figures. FIG. 1 illustrates one embodiment in which satellite 11 and satellite 12 and satellite 13 are orbiting the earth 10. The missions of these three satellites include receiving and transmitting communication signals from stations on earth 10. The mission of satellite 11 requires that the radiation pattern of the antennas is designed to cover the region represented by 14. The mission of satellite 12 requires that the radiation pattern of the antennas is designed to cover the region represented by 15, which is a directive pattern that can be used for security purposes. The mission of satellite 13 requires that the radiation pattern of the antennas is designed to cover a wide region that is represented by 16. For these three different missions, a traditional approach is to have three sets of antennas that produce patterns represented by 14, 15, and 16. This invention allows one to use only one panel, which contains antennas and solar cells, for satellites 11, 12, and 13 by configuring the panel to produce three individual patterns represented by 14, 15, and 16.

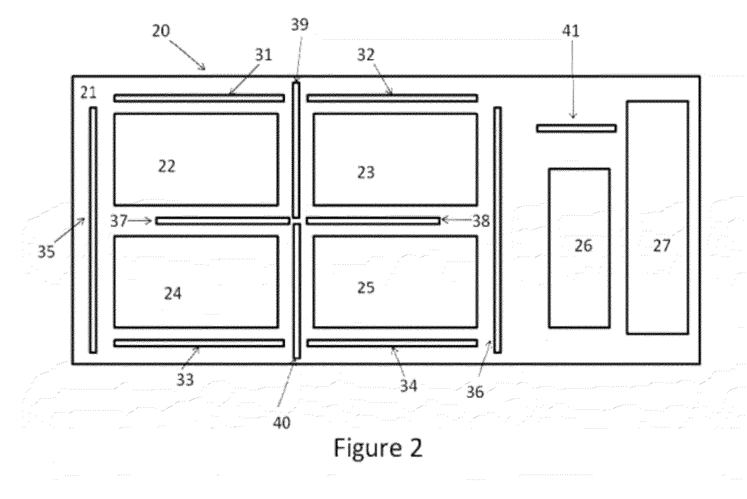

FIG. 2 shows the reconfigurable solar panel slot antenna system 20 is comprised of components and devices 22, 23, 24, 25, 26, 27 mounted on a conductive plate 21, which can be made from printed circuit board material or other suitable conductors. For example, 22, 23, 24, 25 can be solar cells, 26 can be a sensor, and 27 can be another surface mounted device. The location of the solar cells, sensors, and other surface mounted devices 22, 23, 24, 25, 26, 27 on the conductive plate 21 is determined by mechanical design and power requirements, and design parameters for the specific science. For example, power requirements determine the locations and interconnections between solar cells. Specific science mission and mechanical design restrains the location of space instruments. The configurations using these or any other components known by those skilled in the art can be mounted on the conductive plate.

The collection of slot antennas 31, 32, 33, 34, 35, 36, 37, 38, 39, 40, 41 shown in FIG. 2 are located at strategic positions on the conductive plate 21. The positions of the slots are decided by the available surface on the plate 21 and by design strategy. The design strategy includes the provision that, when there is sufficient surface area, the slot needs to be placed in a position that produces the most effective antenna performance. The dimensions, locations, and orientations of the slot antennas are designed such that when powered in certain combinations, they produce the desired radiation patterns. The dimensions and orientations of the slots shown in FIG. 2 are for illustrative purposes and do not limit the possible configurations available for useful applications. In general, the length of the slot is determined by the operational frequency and the material of the plate 21. The width of the slots is determined by the fabrication tolerance such that a thin width is preferred for antenna performance as long as it can be fabricated.

In the example presented, the reconfigurable slot antenna system 20 is integrated into the surface of a satellite. While in orbit, the satellite must be oriented appropriately so that the solar cells 22, 23, 24, 25 can harness sufficient energy from the sun to provide operational power. The sensor 26 and other device 27 are positioned to collect data and perform their desired functions. An antenna system is required to receive and transmit signals for satellite communications. For the case in which a satellite communicates with ground stations and other orbiting satellites, there are large power and system demands on a static antenna system. The radiation pattern for the static antenna system must be sufficient to cover all possible transmitting and receiving station locations.

The reconfigurable slot antenna system disclosed can generate optimum radiation patterns for specific satellite functions, and these radiation patterns can change shape for different functions. For example, referring to FIG. 2, when the satellite desires to communicate with earth and spans a region represented by 14 in FIG. 1, the excitations to slots 31, 32, 33, and 34 could be activated to generate the optimum radiation pattern. When the satellite desires to communicate to a specific region on earth, for example, the region represented by 15 in FIG. 1, the excitations to slots 31, 32, 33, 34, 37, and 38 could be activated and phase shifted to generate the optimum radiation pattern. In order to produce circular polarizations, slots 37, 38, 39, and 40 can be activated and properly phase shifted to produce right-handed and left-handed circular polarizations. To communicate with a large region such as represented by 16 in FIG. 1, slots 31, 32, 33, 34, 35, and 36 could be activated. To operate at a lower frequency, slots 35 and 36 may be activated. To operate at a higher frequency, slot 41 may be activated. The location, shape, and orientation of the individual slots are determined based on design parameters and functional requirements of the satellite.

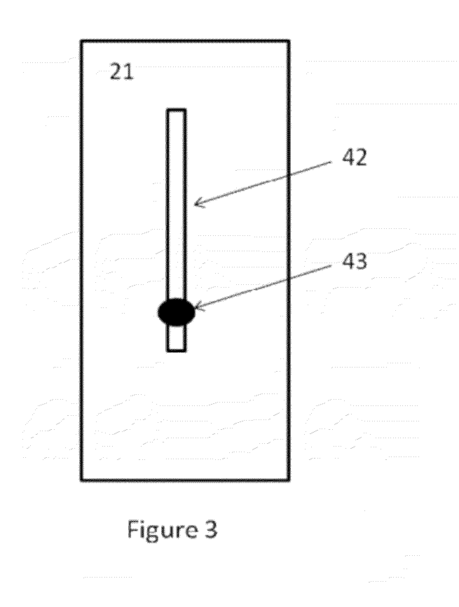

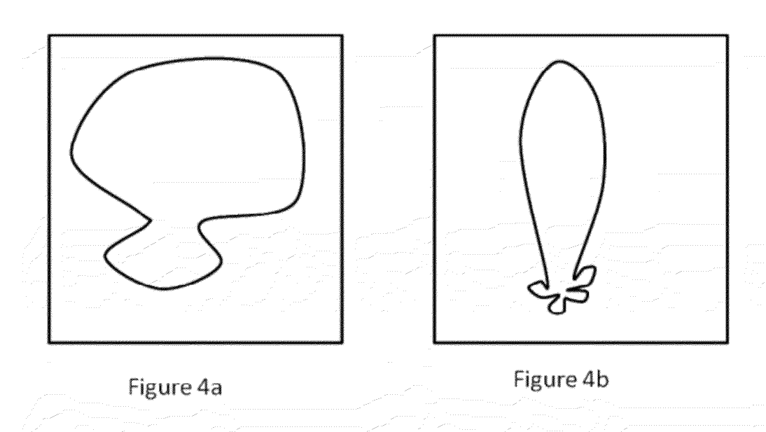

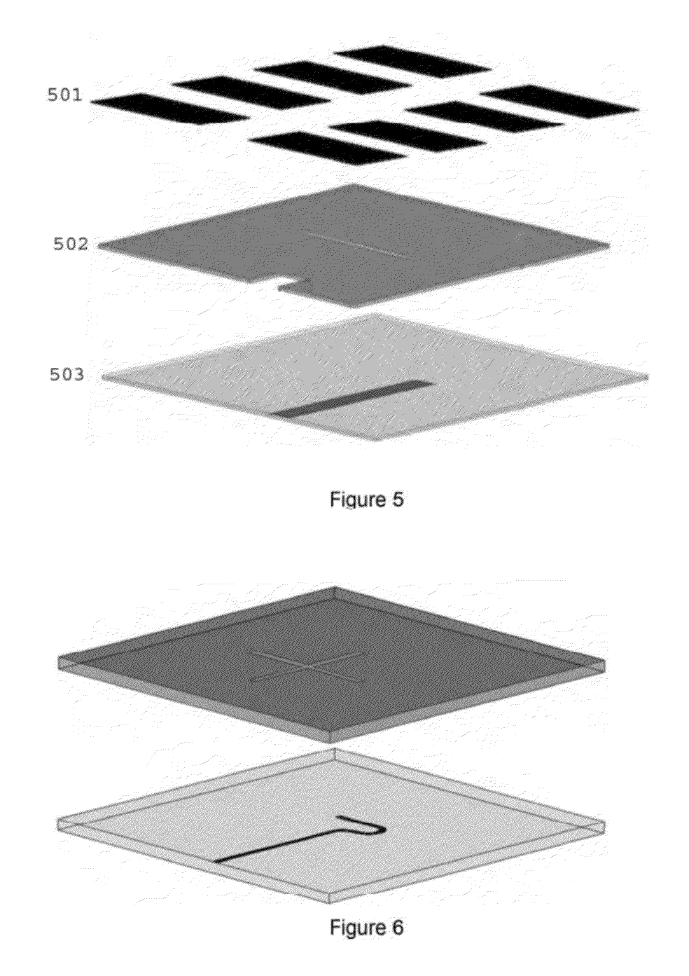

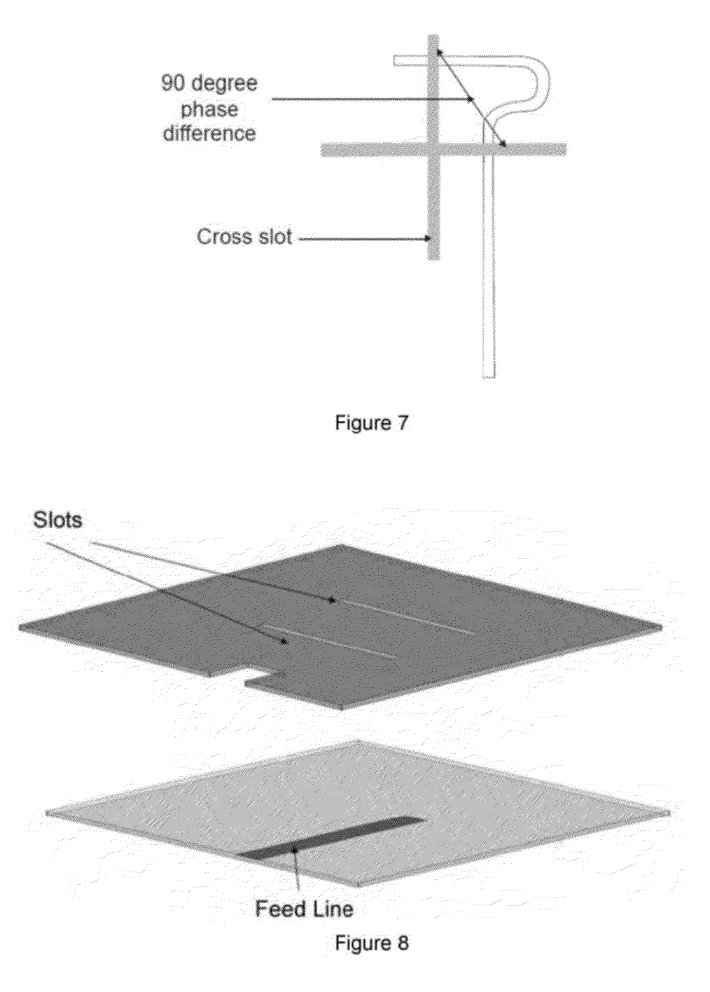

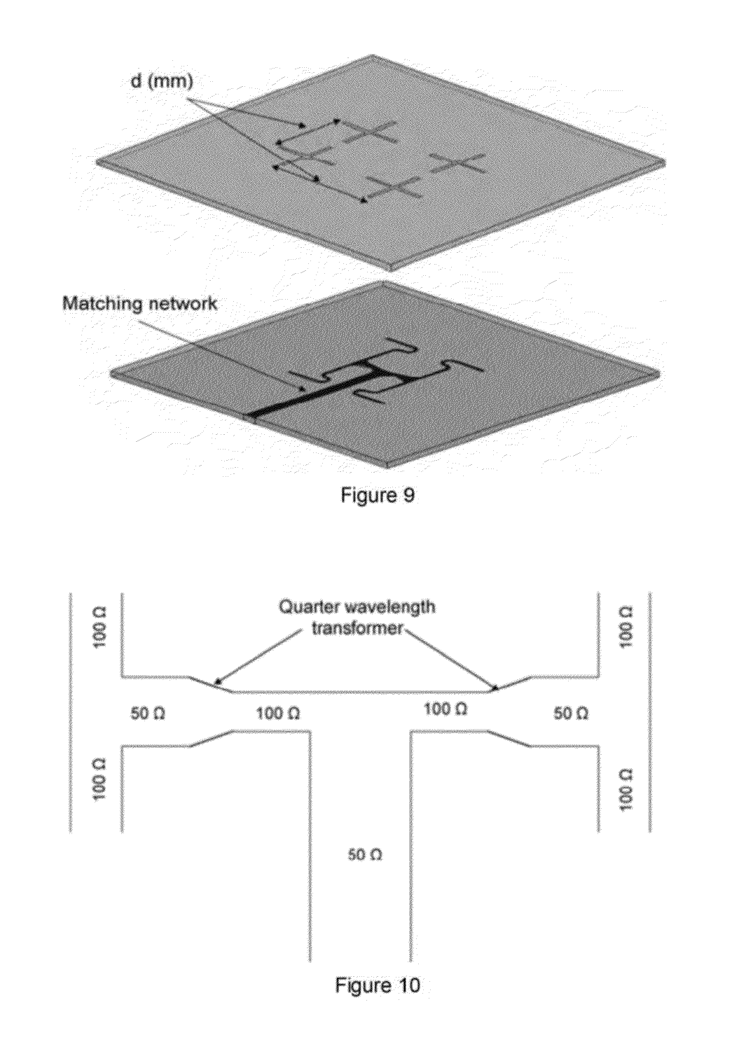

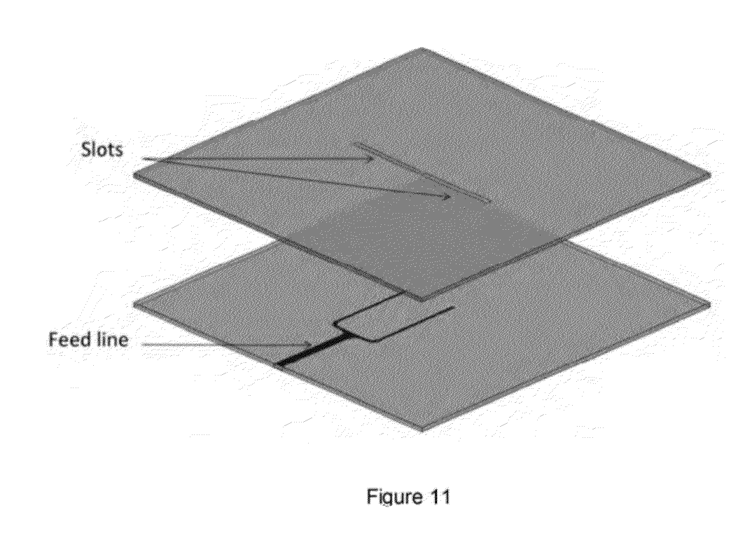

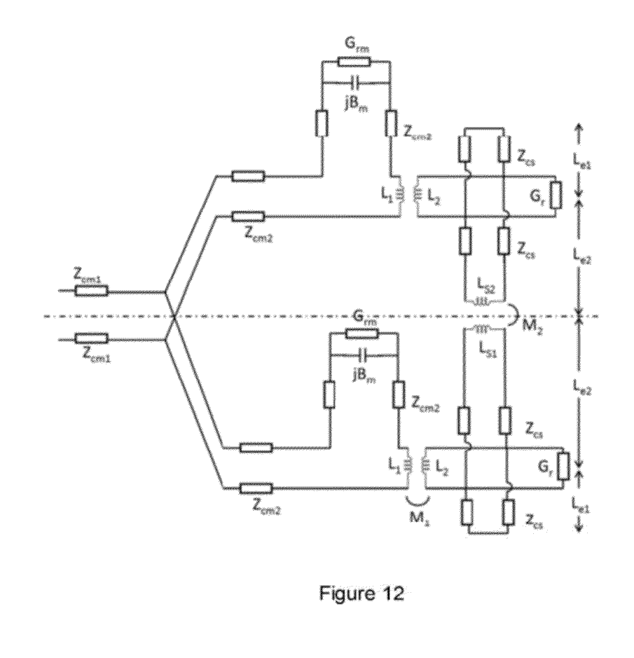

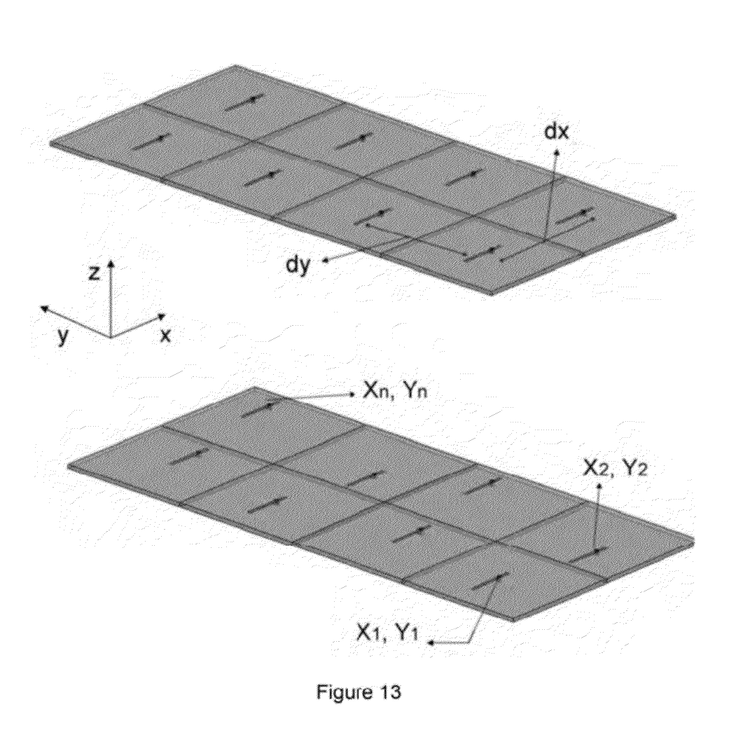

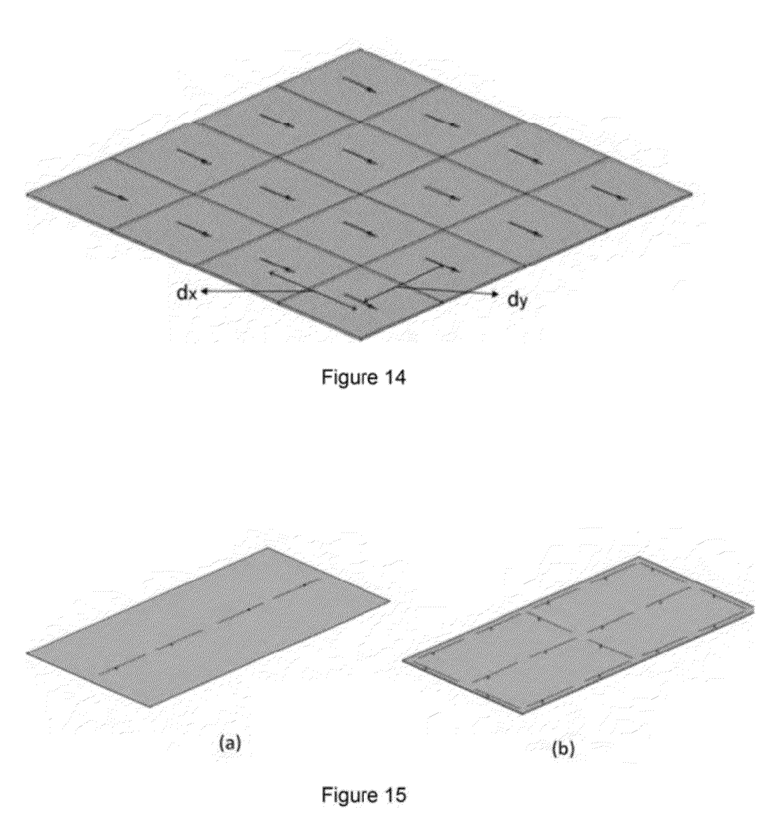

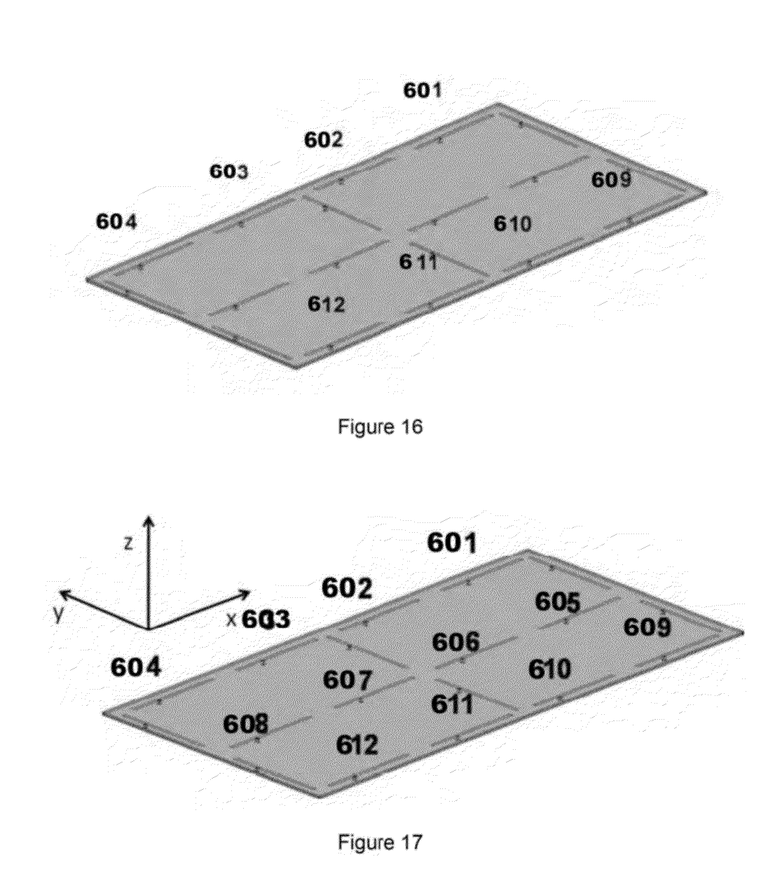

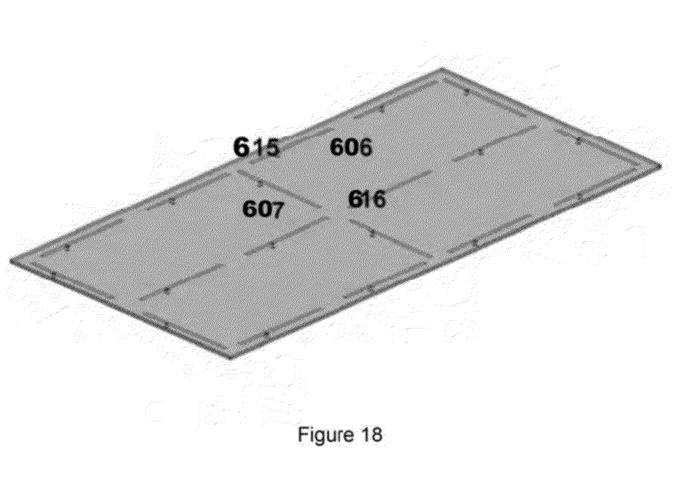

In addition to the location, size, and orientation of the various slots, the excitation feed used to drive each slot, is critical for the performance of the antenna. As explained earlier, the size of the slot determines the operation frequency. The location and excitation determines the shape and polarization of the antenna. The properly designed excitation alone determines the efficiency of the antenna. FIG. 3 illustrates a single slot 42 in a conductive plate 21. For impedance matching, the feed 43 can be offset from the center of the slot 42. The impedance matching is to design the feed of the antenna such as there is minimum reflection between the antenna and the feed and therefore the maximum energy delivered to the antenna is radiated by the antenna. The feed design can be achieve by microstrip lines, coaxial probes, or coplanar waveguides. A commercial phase shifter could be integrated in the feed design. For the reconfigurable slot antenna system shown in FIG. 2, activating or driving and phasing the feed (not shown in FIG. 2) to one or more slots 31, 32, 33, 34, 35, 36, 37, 38, 39, 40, 41 are the means by which the radiation pattern of the system is reconfigured. FIGS. 4a and 4b show two representations of unlimited number of different radiation patterns that can be produced by driving different slot combinations.

The design of the slot antennas is independent of the solar cells, thus there is no need to custom design solar cells. One can use any suitable commercial solar cells. The flexibility of the location of the slots provides more efficient antennas compared to traditional wire antennas. The slots do not occupy additional surface area as traditional patch antennas.

The antenna design of the instant invention is compatible with after-market solar cells. The design is to place cavity backed slot antennas around solar cells instead of under or above them. In doing so, there are no special requirements on solar cells. Among various embodiments linear polarization, circular polarization, and a dual band structure can be achieved.

A typical materiel used to build solar panels on a satellite is Polyimide. The size of a typical one unit (1 U) CubeSat is 10 cm×10 cm×10 cm. The solar cells cover most of the CubeSat's surface. A typical solar panel assembly for small satellites has gaps between the solar cells. These gaps can be utilized to design antennas: create radiating slots in these gaps and have these slot antennas replace the current dipole antennas.

According to Babinets principle, a slot cut on a Perfect Electric Conductor (PEC) can be treated as a complementary dipole. Usually there is a shielding between the solar panel and the electronics inside the satellite; therefore, the slot is only radiating to one side (one plane). A suitable model for such an application is a cavity-backed slot antenna, where a cavity is placed beneath the PEC ground plane. This cavity can be either filled with air or loaded with dielectrics. In one embodiment the slot antenna geometry is as follows: the ground plane is backed by a cavity filled with a substrate, and the relative permittivity of the substrate is 3.5.

How to feed an antenna is an important design factor and it directly affects antenna properties and system level performance. Among many feeding methods, three are more suitable for slot antennas. The three feeding methods are the simple probe feed, Coplanar Waveguide (CPW) feed, and Microstrip Line (ML) feed.

There are mainly two ways to feed a slot antenna with the CPW. The first way is called the inductive coupling which is done by splitting the coupling slot into two by the CPW, and the second is capacitive coupling shown in. The impedance of the CPW can be determined by the length of the etched slot in the CPW. Generally a CPW feeding needs two substrates; the upper substrate contains the radiating slot and the lower substrate contains the etched feeding slot. Although CPW feeding has lots of advantages and can be easily matched, we found that it is not flexible for solar panel application because it causes a poor front to back ratio.

Among the three types of feeding methods, the microstrip line (ML) feed is the most effective and simple to implement. We used three embodiments of ML feeds (regular ML, shorted ML, and tapered ML) to feed a slot antenna. IN this exemplary embodiment the antenna was designed at a center frequency of 5 GHz; the dimension of the ground plane is 50×50 mm, and the slot is 18×1.2 mm. The geometry of the antenna and the feed is as follows. Two substrates are used to fabricate the slot antenna and the feed individually. The top plane of the upper substrate is grounded and a radiating slot is etched on the grounded metal coating. The metal coating on the bottom plane of the substrate is etched out. For the lower substrate, a microstrip line is printed on the top plane; the metal coating on the bottom plane is grounded. The two substrates are then assembled together and the four walls are coated with a conductor and are also grounded.

In one embodiment the two substrates used are both Rogers high frequency laminates (RO 4003C) with the relative permittivity, thickness, and loss tangent of 3.5, 0.813 mm, and 0.002, respectively. A conductive epoxy (Creative Materials product number 124-46) was used to coat and ground the four side walls of the substrates. The dimension of the ground plane is 50×50 mm, and the slot is 18×1.2 mm.

The next step is to integrate the antenna with the solar panel. There are mainly three layers. The first two layers are feed-line 503 and the antenna 502, and the last layer is made of solar cells 501. The solar cells are very thin (about 0.16 mm) semi-conductive layers. As both the dielectric constant and the conductivity of the solar cells cannot be easily found exactly and they may vary among vendors, we treated the solar cell as a silicon layer and varied its conductivity to show that the existence of the solar cells affects the antenna performance.

We placed a silicon layer around a single element slot antenna and varied the conductivity of the silicon. It is seen that the conductivity of the solar cell only shifts the resonant frequency of the antenna and there is no significant shift after the conductivity is raised higher than 5 S/m. As the conductivity increases, the solar cell layer only acts as part of the ground plane and has no large effect on the antenna performance. In order to steer the beam to the earth, one needs to consider an array of slots.

A circularly polarized antenna is highly favored in satellite communication for many reasons. While it is not always simple to achieve CP with dipole antennas, the design is possible for slot antennas. A CP can be obtained as long as we have two slots perpendicular to each other and phase shift them for 90 degrees. To obtain the 90-degree phase shift, a ML feed is used where the feed line is adjusted to feed both slots. The line length between the two elements is designed to give a 90-degree phase delay.

An array configuration not only allows us to steer the antenna beam to the desired location, but also helps to increase the gain of the antenna. Exemplarily embodiments of arrays are presented. One is a two-element LP array to show beam steering. Another is a four-element CP cross slot antennas to show the gain enhancement. It should be noted that one can easily steer the beam and enhance the gain at the same time with a CP slot antenna array.

The distance between two antennas is noted with d in millimeters. The phase delay between the two elements is dependent on d. The spacing between elements is uniform and is lambda/2 where lambda is the wavelength in free space. To facilitate a better matching and an ease in fabrication, two quarter-wave tapered transmission lines are used. The 50-ohm line is then connected to a SMA connecter to feed the array. There are two kinds of ML layouts to avoid reflection at the bending in the microstrip line]: the swept bend and the mitered bend. In this example, the swept bend was used. The radius of the bend was set equal to or more than triple the line width.

The four-element CP array antenna was fabricated using a milling machine on a substrate (RO 4003C). The substrate has a permittivity of 3.5, height of 1.54 mm, and a loss tangent of 0.002. A reasonable CP is achieved.

In an exemplary configuration of a dual band cavity-backed slot antenna, the antenna and the feeding lines are composed of two circuit board substrates. Two slots are etched on the top layer, which is a copper layer, of the first substrate as radiating elements. The feeding lines are printed on the top layer of the second substrate. The bottom layer of the second substrate is the ground plane. The two substrates are then assembled together with an antenna layer residing on top of the substrate layer; the antenna elements are vertical to the feed lines. It should be noted that one does not have to choose the same substrates to etch antenna and to print feed lines. By adjusting the position and length of the feed line the slot antenna can be matched. After assembling the two substrates, the four side walls of the substrates and the top plane (i.e., slot antenna and the metal plane) are shorted to the ground plane with, for example, either conductive pastes or conductive tapes.

When the two elements are placed close, a new resonance appears due to the strong coupling between the two slots. The explanation for the second resonance is that the coupling between the two slots acts as if there is an equivalent slot antenna that is longer than the individual slot; at the same time, it is shorter than the total length of the two slot elements.

In order to analyze the mechanism of the dual band resonance and provide some insight for designing effective antennas for both frequencies, we established an approximate circuit model to study the input impedance of the slot antenna. Both Le1 and Le2 are important for matching the impedance of the two slots, and d has been seen to affect the impedance of the equivalent slot. Each slot is modeled as two short-circuited slot lines parallel with a radiation conductance Gr that represents the radiated power from the slot. The parameters Le1 and Le2 correspond to the length of the two short-circuited slot lines. The characteristic impedance of the slot line is Zcs. L1, and L2 are inductance of the microstrip feed line and slot line, respectively. The mutual inductance M1 represents the coupling between the microstrip line and slot line.

The mutual inductance M2 represents the coupling between two serial slots. Because of the coupling, there appears an equivalent slot that radiates at a frequency lower than the two slots. The length of the equivalent slot is Leq, and is expected to be between (Le1+Le2) and 2 (Le1+Le2). The coupling between the two slots reflects as added impedance Zcouple to the equivalent slot line. It is straightforward to expect that changing the spacing d between the two slots will change M2, and accordingly change Zcouple, where Zcouple is the dominant factor for the input impedance of the equivalent slot because the other factors (characteristic impedance Zcs, radiation conductance Ger, and the length Leqtot of the equivalent slot line) do not vary much with respect to d. Therefore, after matching the impedance of the two slots, one can adjust the spacing between the two slots to achieve a reasonable return loss for the equivalent slot antenna.

Ansoft's HFSS is used to perform the simulations for two serial slot antennas on substrates with different thickness and relative permittivity, and different ground plane size. It is found that after matching two identical serial slots to a resonant frequency f1, a secondary resonance f2 (f2≦f1) appears when the spacing between the two slots is less than 0.19 wavelength. This resonance is generally weak with an S11 higher than −3 dB and we need to continue to move the two slots closer to achieve a reasonable S11 at f2. It is observed that changing the spacing only changes the level of the resonance, and does not have much effect on f2. It is also observed that the spacing affects the resonance at f1, and one has to adjust the matching microstrip lines to achieve a good S11 at f1. As with the case for f2, the spacing between two slots does not affect the location of f1. These observations are consistent for different substrates and ground plane sizes, and they are also consistent with the model. When the dimension of the slots is fixed, the input impedance of the equivalent slot is mainly determined by Zcouple which is affected by the mutual inductance M2. It is also seen that M2 affects the input impedances of two serial slots, and therefore the spacing between them will affect the S11 value at f1. The ratio of f1/f2 is found to be close to 1.25, the fluctuation is less than 5% for different substrates and ground plane. The ratio between the length of the equivalent slot and one of the serial slots is about 1.25.

The substrates for one embodiment of a dual band slot antenna prototype are Rogers high frequency laminates RO 4003c (thickness=0.831 mm, permittivity=3.38) and the two slots are designed and matched to operate at 5.26 GHz. The equivalent slot operates at 4.22 GHz. The spacing between the two slots and the position of the microstrip feed line are adjust to be d=0.5 mm and Le1=1.5 mm to achieve good S11 values at both frequencies. The antennas and the feeding microstrip lines were fabricated using a Lighted Program Function Keyboard (LPKF) circuit board milling machine, and the ground plane or the size of the substrate was chosen to be 100 mm×100 mm. The two slots on the upper plane have the same width of 1 mm and the same length of 25 mm. After assembling the two substrates, the four size walls were shorted with conductive copper tapes.

A further embodiment consists of a linear array antenna consisting of two series elements. The structure was as follows: two substrates, the lower substrate for the feeding network and the upper for the slot antennas etching. The substrate was made from Polyimide, a material which is commonly used for space applications. Finally, a layer of solar cells was integrated with antennas on the top layer. For the feed layer is a 50-ohm microstrip line was etched to be connected to the SMA connecters, this line is then divided using a tee junction into two different lines each having a characteristic impedance of 100-ohm. Each line is feeding a separate element. The parameter (d) was used to match the microstrip line to the slot antenna. The antenna layer is two slots etched in a metallic ground plane. The slots were half wave length each, with a spacing of 0.6 wavelength. This value was chosen because it is typically less than a wave length to avoid grating lobes and not small to decrease the coupling effect. The solar cells were modeled as very thin silicon layers with certain conductivity.

For the dual band antenna array, the slot locations were chosen to be at the edges of the solar panels, rather than the center, for two reasons. The first reason is to achieve a more omni-directional pattern which is frequently required in space applications. The second reason is due to the realistic electric connection and the size of solar cells. A 50-ohm probe was placed at the center of the panel which can be connected to an SMA connector for excitation. The probe is connected to a 50-ohm microstrip line, each end of the line is then increased to 25-ohm line by a lambda/2 tapered transformer. The 25-ohm line is divided in to two equal 50-ohm lines; therefore we have a total of four 50-ohm lines. Each of these four lines is then divided into two 100-ohm lines, so that in the end we have eight equal 100-ohm lines to feed eight slot antennas. Dual band performance in space applications is important because it saves money since one antenna will be performing the job of two. It also saves additional surface area, which is an important factor especially for small satellites. The design of one embodiment of antenna array has eight antenna elements that radiate at a given resonant frequency and two adjacent elements in the center coupled to each other to create a lower resonance as the second band.

It is worthwhile to explain the choice of solar/antenna panel material. Commonly used planar antenna materials like FR4 and high frequency laminates would not handle either the temperature or the pressure in outer space. For example, FR4 material has an expansion coefficient in the x-y plane (width and length, not the thickness) of 16 ppm (particle per million). This expansion coefficient in the case of a 2.4 GHz antenna design may cause a shift of 0.2 GHz in the main frequency. Polyimide is a better candidate because it has a very low expansion coefficient (almost one quarter the FR4), and has been mechanically tested and proved to handle the pressure and temperature fluctuation in the outer space. The trade off, however, is the loss of the Polyimide at GHz frequencies. The typical efficiency for slot antennas on a high frequency laminates ranges from 60 to 80%, but for Polyimide the efficiency of the antennas is ranging from 40 to 60%. Considering the overall performance and the link budget, Polyimide is still one of the best choices at this time.

When prototyping embodiments of antennas with PCB technology, a mask is prepared for each layer and the nonmetallic parts were etched out from the layer. A three-layer board was designed. We have a lower ground plane and an upper ground plane. They were connected using vias which were separated from each other by lambda/4 spacing. The middle layer is the feed network layer. The slot antennas in this embodiment have a length of 28 mm that corresponds to a length of lambda/2 at 2.5 GHz. Three feed designs were etched in the middle layer. The linear antenna array and CP antenna have ground planes of 155 by 96 mm and the dual band antenna had a ground plane size of 190 by 96 mm.

After the antennas were fabricated, 28.3% ultra triple junction solar cells were assembled in series. Each solar cell provides an output voltage of 2.5 volt and current of 450 mA. The solar cells were all connected in series to provide an output voltage of 10 volts to power the electronics inside a cube satellite. The solar cells were attached using an adhesive material (part no. CV10-135 from NuSil Technology LLC). The assembly process was performed in a vacuum chamber to ensure that the solar cells were perfectly connected to the panel.

One antenna in the instant embodiments can perform the role of three or more antennas. When the size of the solar panel permits an array of slots instead of only one or two slots, then it is not only desirable but also feasible to locate these slots in positions that can provide the most optimal antenna performance. Various exemplary embodiments are presented to optimize antenna performance in an array configuration.

In one embodiment the antenna layout is configured to give the optimum pattern with suppressed side lobes. One example of this embodiment of the solar panel has a dimension of 20 cm×10 cm; this solar panel can easily allow multiple slots integrated on it. In general, the process of optimization is to adjust the inputs of a system (in this case, the antenna design parameters) and then find the maximum (or minimum) output. The process of finding the optimal output is called the cost function or objective function. Three optimization methods are Quasi Newton (QN) method (gradient methods), the Linear Programming (LP) method (simplex search method), and the Genetic algorithms (GA). The cost function may be chosen to be the lowest side lobes in the radiation pattern. For a planar array, the antenna elements can have equal or unequal spacing, and these two types of layout are called linear and nonlinear configuration. The field pattern of a planner antenna array is the multiplication of the array factor and the element pattern (field pattern of the antenna element that constructs the array) as follows.

[Fₜ]=[AFₓ]:[AF_{y}]:Fₑ

where [Fₜ] is the total field pattern of antenna array, [AFₓ] is the array factor of the arrays on x axis, [AF_{y}] is the array factor of the arrays on y axis, and Fₑ is the element pattern.

There are eight elements in this embodiment, four elements are on the x axis, and two are on y axis. Therefore the array factors [AFₓ] and [AF_{y}] can be written as follows.

[AFₓ]=cos[0:5(Kdₓ cos(θ))+βₓ]

where k=2n/λ, dₓ=separation between the elements, βₓ=phase difference between elements, and λ=wavelength.

AF_{y}=(1/N)(sin(N/2ψ))/sin(a/2ψ)

where ψ=(Kd_{y} cos θ)+β_{y}, N=4, d_{y}=separation between the elements, and β_{y}=phase difference between elements.

To search for the optimum pattern, set [Fₜ] as the cost function and select from all three optimization methods. The simplex search method took the least number of iterations. The GA method converges after about 20 more iterations than the simplex search method, and the QN method did not converge. The reason for the failure in QN can be due to the noise generated by the meshing process in HFSS, and the QN method works well only with low noise, unlike the simplex search method and GA that are not affected with the noise.

Generally, GA are robust and stochastic optimizers modeled on the principle of natural selection and evolution. GA is effective in solving complex problems with many variables or mufti-objective function.

There are four variables to adjust (dx, βx, dy, βy). To search for the optimum pattern, set [Ft] as the cost function and utilize the optimization methods. The optimized values for QN are: dx=42.1 mm, x=1.2, dy=44.6 mm, y=0.8. The optimized values for LP are: dx=36.2 mm, x=0.5, dy=34.8 mm, y=0.4. The optimized values for GA are: dx=36.6 mm, x=0.3, dy=34.4 mm, y=0.4.

Another embodiment is to optimally steer the antenna main beam. In this embodiment, a total of 16 slot antennas 601, 602, 603, 604, 605, 606, 607, 608, 609, 610, 611, 612, 613, 614, 615, 616 are placed on a larger panel (20 cm×20 cm). The variables to be optimized are the position of the antenna elements on the panel. The cost function is chosen to steer the main beam and to suppress the side lobes. GA is used to perform the optimization. When minimizing the side lobes, the main beam can be steered up to 35 degrees, which satisfies most communication requirements.

A further embodiment is to optimize the efficiency of the antenna array. The size of the panel and the variables to be optimized are the same as above. The relation between the antenna gain and the efficiency is given by:

Gain=efficiency×directivity

The cost function in this case is set to be such that it maximizes the efficiency of the antenna array. The efficiency of an 8-element antenna array and a 16-element array were optimized and increasing the number of elements results in higher efficiency.

A further embodiment used a solar panel (10 cm×30 cm) to allocate multiple slot antennas to obtain reconfigurable patterns. Eighteen possible slot antenna locations were considered 601, 602, 603, 604, 605, 606, 607, 608, 609, 610, 611, 612, 613, 614, 615, 616, 617, 618. Three basic patterns were targeted to achieve: the isotropic, dipole, and directive patterns. These patterns were obtained by activating and phasing slot elements. The coupling effect between the slot antenna elements is taken in consideration. Some elements will not be activated during certain configurations, but this does not mean they do not radiate or disturb the primary pattern. In one embodiment, two different antennas were implements for a four-element slot array. One set contains four active slots, and the other set has non-activated slots next to the four primary slot antennas. Radiation patterns from the two set of antennas were compared to understand the effect of the coupling on our primary pattern. Coupling has an important role and cannot be neglected. We use this coupling to our advantage to help improve the radiation patterns, especially in the case of achieving an isotropic pattern. Three different radiation patterns were obtained by activating and phasing different slot elements. A circular polarization was achieved on the same panel.

An isotropic pattern is widely adapted for space applications. An isotropic-like pattern was obtained by activating the outer eight elements (601 to 604 and 609 to 612) on the solar panel. No phase shifting between the elements was considered. When those elements were activated together with the effect of coupling, a radiation pattern was obtained. Small nulls were noted in the pattern, but the overall radiation is an acceptable isotropic-like pattern.

Twelve elements (601 to 612) were activated to get a dipole-like pattern. No phase shifting was applied between these elements. The radiation pattern in this configuration resembles a dipole antenna.

A further embodiment was a directive end-fire pattern. The advantages of this pattern are the high gain and directive characteristics that can be beneficial for applications where high gain and security considerations are needed. The same twelve elements activated in the dipole-like pattern antenna were used, but this time with phase shifting applied. The phase shifting was applied only in the x direction making the array directive in this direction.

In a further embodiment, by activating the four elements (606, 607, 616, and 617) in the center and phase shifting them by 90 degrees, a circular polarization was obtained. An axial ratio of 0.5 dB was obtained, showing a very good circular polarization.

The above description discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

1. A system for receiving and transmitting electromagnetic waves comprising:
a plate made from a conducting material;
one or more slots fabricated into said plate;
one or more feeds coupled to each said slot; and
a means to independently activate each said feed to cause said slots to radiate.

2. The system of claim 1 wherein said slots are various lengths and widths, and positioned at various desired locations and orientations on said plate.

3. The system of claim 1 further comprising a control system to activate one or more said feeds simultaneously to produce a desired radiation pattern.

4. The system of claim 3 wherein said control system can activate and deactivate one or more said feeds to dynamically reconfigure the desired radiation pattern.

5. An integrated solar panel and slot antenna system comprising:
a solar panel comprising active solar cells and a supporting infrastructure;
a plurality of slots fabricated into said solar panel supporting infrastructure;
one or more feeds coupled to each said slot; and
a means to independently activate each said feed to cause said slots to radiate.

6. The system of claim 5 wherein said slots are various lengths and widths, and positioned at various desired locations and orientations on said solar panel.

7. The system of claim 5 further comprising a control system to activate one or more said feeds simultaneously to produce a desired radiation pattern.

8. The system of claim 7 wherein said control system can activate and deactivate one or more said feeds to dynamically reconfigure the desired radiation pattern.

9. The system of claim 8 wherein said control system is configured for circular polarization.

10. The system of claim 8 wherein said control system is configured for minimization of side lobes.

11. The system of claim 8 wherein said control system is configured for a directive end-fire radiation pattern.

12. The system of claim 8 wherein said control system is configured for an isotropic pattern.

13. The system of claim 8 wherein said control system is configured to operate as a dipole.

14. The system of claim 5 wherein said slots are configured in said solar panel without diminishing the light conversion effectiveness of said solar panel.

15. The system of claim 5 wherein said system is deployed on a satellite.

16. The system of claim 5 wherein said plurality of slots comprises one slot that is perpendicular to another slot.

17. The system of claim 5 wherein said plurality of slots comprises one slot that is collinear to another slot.

18. The system of claim 5 wherein said plurality of slots comprises one slot that is parallel to another slot.

19. The system of claim 5 wherein said supporting structure is made from a conducting material.

20. The system of claim 5 wherein said supporting structure is made from a non-conducting material.

21. An integrated solar panel and slot antenna system comprising:
a solar pan& comprising active solar cells and a supporting infrastructure;
a plurality of slot antennas attached to said solar pan& supporting infrastructure;
one or more feeds coupled to each said slot; and
a means to independently activate each said feed to cause said slots to radiate.
